(19) United States
(12) Patent Application Publication
(10) Pub. No.: US 2003/0101214 A1
(43) Pub. Date: May 29, 2003

(54) Allocating data objects stored on a server system

(75) Inventors: David B. Kumhyr, Austin, TX (US); Margaret Gardner MacPhail, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/996,130

(22) Filed: Nov. 28, 2001

(51) Int. Cl. G06F 15/16

(52) U.S. Cl. 709/203

(57) ABSTRACT

A system, method, and computer usable medium for allocating data objects stored on a server system. At least one user group is provided. Tag information for the data objects is determined. At least one group interest for the user group is determined. It is determined whether the tag information corresponds to the group interest. If there is correspondence, data objects including tag information of said group interest are placed into a server cache.

### TECHNICAL FIELD OF THE INVENTION

The present invention relates generally to computer servers and in particular to allocation of data objects stored on a server system.

### BACKGROUND OF THE INVENTION

Computer server systems may be coupled electronically to a plurality of client computer systems through a network environment, such as the Internet. The client computer systems may request information from the server, at which point the appropriate information may be retrieved. The server systems may store information on a plurality of hard-drive type disks. Furthermore, the information may be distributed evenly across the disk array. One disadvantage of this storage methodology is that related information, or data objects (i.e. a single file, Web page, or the like), may be stored on more than one member of the disk array. Disk operations requiring multiple-disk access typically require more time than single-disk functions. Thus, a user accessing and retrieving the data object may unnecessarily experience increased access and download times.

Several strategies have been developed to strategically place often accessed data objects in a disk cache thereby reducing access and download times. For example, “popular” Web pages may be placed in the disk cache to anticipate future access demands. Such strategies may allow effective data object caching based on past access patterns. Such strategies, however, may not be capable of anticipating recent or future events requiring alternative object caching. For example, a recent news development may lead to numerous hits to a previously unpopular Web page. As such, it would be desirable for a data object allocation strategy to utilize past access patterns as well as anticipate future access demands.

Another shortcoming of current disk caching strategies pertains to user groups. In many instances, these strategies do not take into account common access patterns typically shared by a given user group. For example, users belonging to a “marathon runner's” group may be interested in Web pages pertaining to a novel design in running shoes. As such, it would be desirable for a data object allocation strategy to ascertain common access patterns typically shared by a user group.

Therefore, there is a need for an improved strategy for allocating data objects stored on a server system that overcomes the above and other disadvantages.

### SUMMARY OF THE INVENTION

One aspect of the invention provides a method and a computer usable medium for allocating data objects stored on a server system. At least one user group is provided. Tag information for the data objects is determined. At least one group interest for the user group is determined. It is determined whether the tag information corresponds to the group interest. If there is correspondence, data objects including tag information of said group interest are placed into a server cache. The data object may include a Web page. The Web page may include information provided as hypertext mark-up language (HTML) or extensible mark-up language (XML), including tag information provided as hypertext transfer protocol (HTTP). Determining tag information may include reading data object tag information and may include generating data object tag information. Determining at least one group interest for the user group includes managing predictive data. Managing predictive data may include considering static predictions and access patterns. Determining at least one group interest for the user group may include determining interest match information and may include determining an interest relevance score. Determining whether the tag information corresponds to the group interest may include determining interest match information and may include determining a pertinence score.

Another aspect of the invention provides a system for allocating data objects stored on a server system. The system includes a means for providing at least one user group and means for determining tag information for the data objects. The system also includes means for determining at least one group interest for the user group. The system further includes means for determining whether the tag information corresponds to the group interest, and if there is correspondence, placing data objects including tag information of said group interest into a server cache.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is one embodiment of an electronic system utilizing the present invention;

FIG. 2 is a Web page including a typical HTTP header incorporating an attribute tag according to one embodiment of the present invention;

FIG. 3 is a flow diagram showing one embodiment of the present invention implemented in the electronic system of FIG. 1; and

FIG. 4 is an XML group template according to one embodiment of the present invention.

### DETAILED DESCRIPTION OF THE PRESENTLY PREFERRED EMBODIMENTS

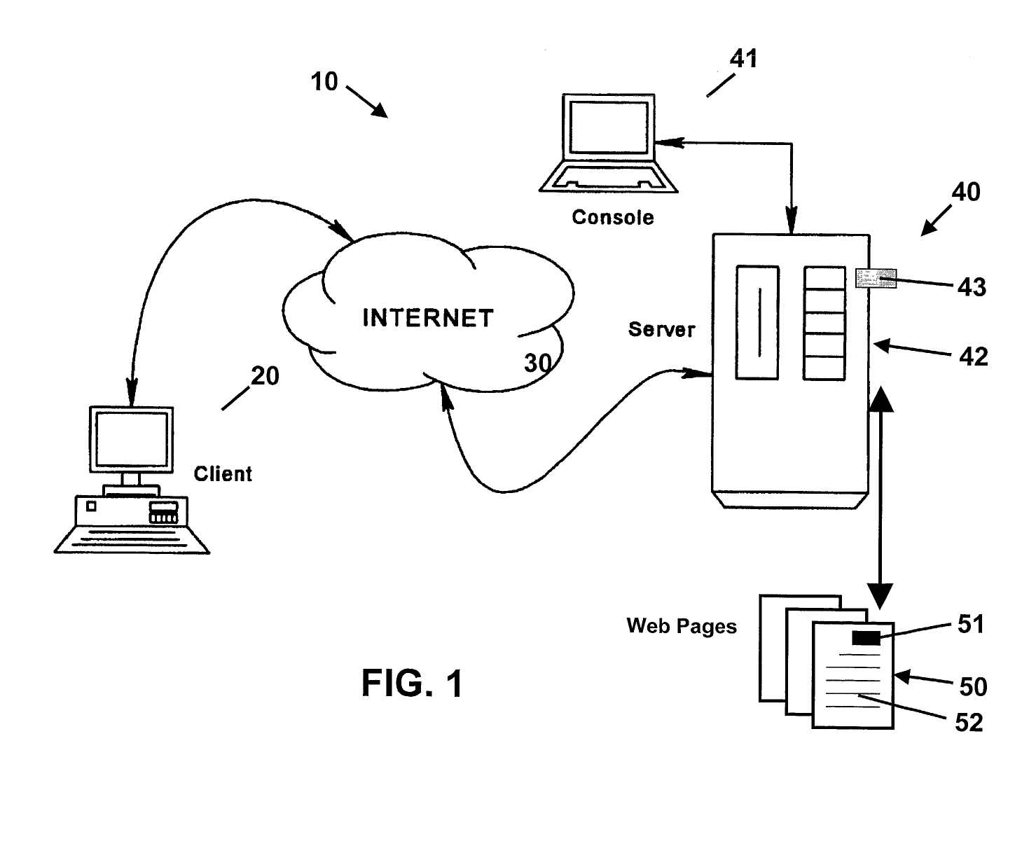

One embodiment of an electronic system utilizing the present invention is shown generally in FIG. 1 as numeral 10. A client computer system 20 may be electronically coupled directly or through an Internet service provider (ISP) to the Internet 30. Likewise, a server computer system 40 may be coupled to the Internet 30 or wide area network (WAN). As discussed herein, a client computer system 20 is an electronic system that establishes connections for the purpose of transmitting requests and a server computer system 40 is an electronic system that accepts connections in order to service requests by transmitting responses.

The server computer system 40 may include one or more server computers linked together, as through a local area network (LAN), for storing and exchanging a body of information or data. Connections, in the forms of electronic communication, may be established between the server system 40 and one or more client computers 20 for information exchange. A console 41 may provide means for controlling and accessing the server system through a user interface (e.g. use of a computer keyboard). Those skilled in the art will recognize that the present invention may be effectively used with a variety of client/server system configurations and that the present system description is not intended to be absolute. Numerous modifications, substitutions, and departures from the system may be made without limiting the function of the invention.

The server computer 40 may include a disk array 42, including a cache 43, for storing the information. The disk array 42 may include at least one hard drive-type disks commonly used in computer server systems. In one embodiment, the cache 43 may include at least one high-performance hard drive disk for increased information retrieval rate. In another embodiment, the cache 43 may include Random Access Memory (“RAM”), non-volatile RAM, zip memory, and the like. The information stored on the disk array 42 and cache 43 may include data objects. The data objects may include information in the form of computer files, data, or the like. In one embodiment, the data objects may include Web pages 50. The Web page 50 may be a document written in Hypertext Markup Language (HTML) or extensible mark-up language (XML), although the spirit and scope of the invention is not limited to Web pages written in HTML or XML. Furthermore, the Web page 50 may contain data in the form of textual, video, audio, hyperlink, computer program information, or combinations thereof.

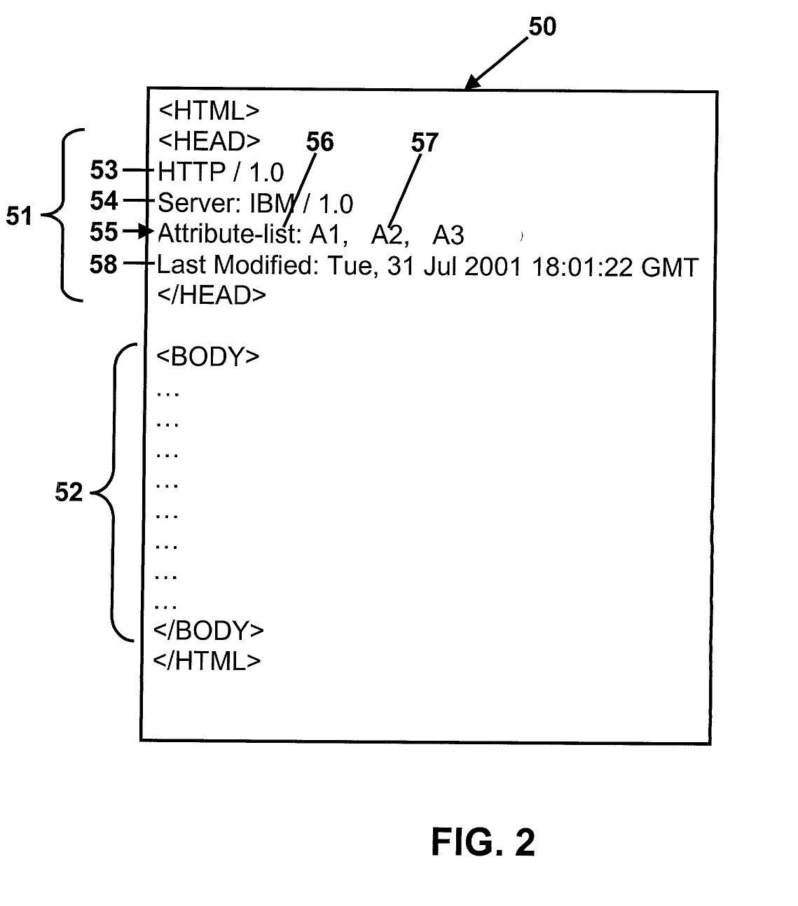

As further shown in FIG. 2, the Web page 50 may include a Hyper Text Transfer Protocol (HTTP) header 51 and information body 52. The header 51 may include information pertaining to the protocol and version supported 53, the type and version of the server 54, and the date and time that the Web page was last modified 58. The header 51 may further include an attribute tag 55. The attribute tag 55 may be created, added, appended, inserted, or embedded into the header 51. This process may be performed manually or by an automated process of the server computer 40.

The attribute tag 55 may include an identifier 56 followed by an attribute list 57. The identifier 56 may indicate that the attribute list 57 is to follow. The attribute list 57 may be a list of at least one significant keyword or term that is descriptive of the contents of the Web page 50. For example, “A1, A2, A3” in the attribute list 57 may be “Boston, running, marathon”. Thus, examination of the attribute list 57 may reveal that the Web page 50 pertains to the Boston marathon. The attribute tag 55 may also include a short narrative describing the Web page, a list of embedded links (e.g., addresses of other Web pages) in the Web page, or any other information that describes the contents of the Web page. The size, nature, and length of the attribute tag 55 are not fixed and may vary depending on the size and contents of the Web page 50.

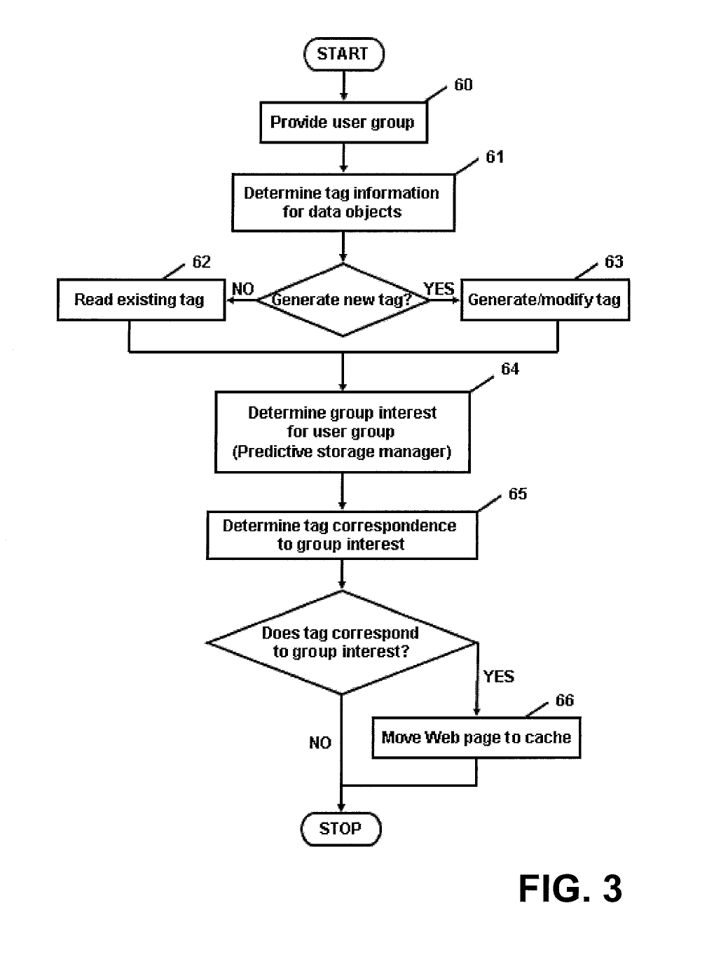

FIG. 3 is a flow diagram showing a method of the invention implemented in the electronic system of FIG. 1. In one embodiment, the method may be in the form of an algorithm written in computer readable program code run by the server system. At any point of the algorithm, decisions and functions may be controlled and performed manually by a user or system administrator (i.e. through a console linked to the server system) or automatically (i.e. through a programmed algorithm). As previously described, a plurality of Web pages stored on a server system disk array may each contain a HTTP header. The header may contain an attribute tag including an identifier followed by an attribute list.

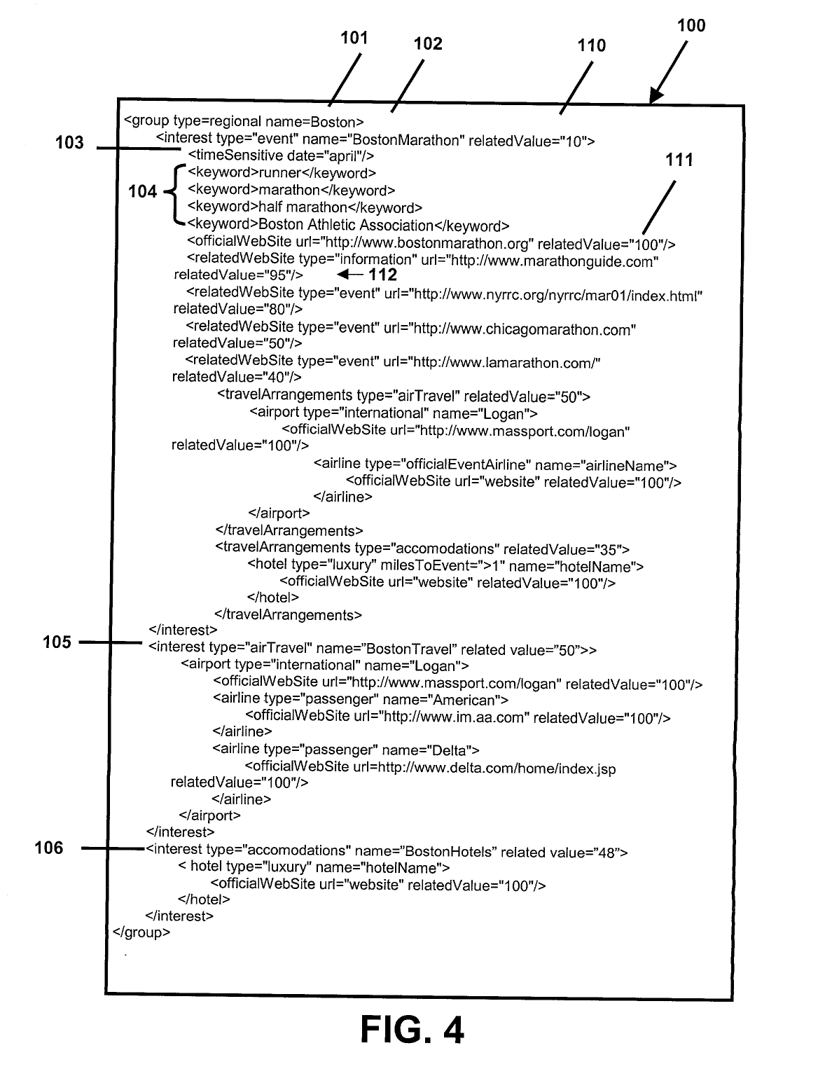

At least one user group is provided (Step 60). In one embodiment, a user group may be defined manually or automatically as described above. The definition of user groups may include explicit definition, discovery processes, surveys, overall web-access patterns, and linking of small patterns to form larger patterns. In one embodiment, explicit definition may include explicitly naming users to a given group. For example, groups may be defined by a system administrator, such as by a common interest (i.e. city, event, sports team, political party, etc.). In another embodiment, the discovery process may include extracting information from users or their access patterns. For example, a user may submit personal data such as a phone number area code or address. This information may be utilized to form a group with those users residing nearby. In another embodiment, groups may be defined through surveys, such as by shared responses to a survey. For example, an online survey querying users about their location may be used to define a “Boston” user group. In another embodiment, overall web-access patterns may be utilized to define a user group. For example, user browsing patterns may be monitored and matched with patterns of other users to form a group. In another embodiment, these browsing patterns may be linked to form larger patterns. For example, some users belonging to a group may also share browsing patterns with another group(s). Therefore, a novel user group may be formed with members of the smaller groups. Typically, a user group includes a plurality of users accessing Web pages on the server wherein the group may share common access patterns. Those skilled in the art will recognize that numerous strategies are possible for providing user groups. User group information may be stored in a group template for coordinating the allocation of Web pages stored on a server system. As shown in FIG. 4, the user group definition may be incorporated as part of a XML group template 100. In this example, the group may represent those users associated with Boston 101. A group template is merely one example of how information may be organized to perform the functions associated with the present invention.

Referring again to FIG. 3, tag information is determined for the Web page (Step 61). A decision may be made to generate a new attribute tag for the Web page. The Web page may be scanned and a new attribute tag may be generated and inserted into the header in a manner known in the art (Step 62). A new attribute tag may be required if, for example, the existing attribute list does not adequately nor accurately reflect the Web page subject matter. In addition, the new attribute tag may utilize any portion of the existing tag while generating another portion. If a new attribute tag is not required, an existing tag may be read from the Web page header (Step 63). After the attribute tag has been generated, modified, or read, a decision may be made to examine another Web page.

At least one group interest is determined for the user group (Step 64). In one embodiment, the user group interest may be determined by managing predictive data. The process may be controlled by a predictive storage managing algorithm. Managing predictive data may include considering cyclical events, static predictions, and access patterns. For example, a system administrator may explicitly designate that a given group has an interest in a certain topic or event. As shown in the group template of FIG. 4, the Boston user group 101 may have an interest in the Boston Marathon event 102. This interest may be determined by either a static or dynamic process. These processes are intended to handle current increases in Web page requests for a given user group. In addition, the processes are capable of anticipating future increases in Web page requests. In a static prediction process, interests may be designated and added to the group template 100 by either a manual or automatic process (i.e. a proprietary algorithm or system administrator input). The static prediction may be designated as a result of any number of circumstances associated with increasing the request of certain data objects. For example, one might predict that certain Web pages accesses will soon increase based on a recent news development or upcoming event. Therefore, a static prediction may be designated for group interests based on these events. Static prediction allows user group interests to be defined in advance (an upcoming event) as well as in a real-time manner (a current event).

As with the definition of user groups, a dynamic determination of interests may include discovery processes, surveys, overall web-access patterns, and linking of small patterns to form larger patterns. These strategies may typically utilize information gained from user access patterns to determine various interests. In one embodiment, interests determined in a dynamic process may utilize Web page access pattern information. The access pattern information may be used to continuously update and modify the group interests. For example, user groups may change their overall browsing behavior over time reflecting their changing interests as a group. Such changes may be utilized in a dynamic process to continuously update and modify the group interests. In another embodiment, an interest may be determined based on the demand for data matching certain keywords, data related to other data, or data accessed on certain dates or from a certain source/location. For example, the predictive storage manager may recognize that Web pages hits related to the Boston marathon are increasing. Therefore, topics related to the Boston marathon such as air travel 105 and accommodations 106 may be designated as group interests.

The level of interest of a given topic, such as the Boston Marathon, may be quantified by an interest relation value 110. As part of either the static or dynamic interest determination processes, an interest relation value 110 may be assigned to designate how interested the user group is in that topic. In one embodiment, the designation may be made on a percentage scale. For example, a value of “10” may designate that 10 percent of the Boston user group is interested in the Boston Marathon.

Referring again to FIG. 3, it is determined whether the tag information corresponds to the group interest (Step 65). In one embodiment, Web page tag information is compared to group interest match information to determine a pertinence score. As shown in the group template of FIG. 4, the group interest match information may include date 103 and keyword 104 data. The date 103 data may include information such as time, date, and year. This information is generally used to match a group interest with Web pages by anticipating cyclical events. For example, the “April” 103 designation may be used to match Web pages corresponding to that month. The keyword 104 data may include one or more keywords that are associated with a given interest. This information is generally used to match a group interest with Web pages by keywords or shared phrases. The group interest match information may be compared to Web page attribute tags to determine a pertinence score 111, 112. For example, comparison of the date 103 and keyword 104 data to an attribute tag of the official website of the Boston Marathon may produce a high pertinence score 111. In one embodiment, the score may be made on a percentage scale. For example, a value of “100” may designate that there is 100 percent correspondence between the interest match information and the Boston Marathon Web page. As another example, a pertinence score 112 of “95” may be produced for the Marathon Guide Web page.

Once the pertinence score is determined, the Web pages with desirable scores may be designated to correspond to the group interest. In one embodiment, a correspondence cut-off level may be provided to designate the number of Web pages moved to the cache. For example, a high cut-off level may designate that only pages “highly relevant” to the group interest are to be moved to the cache. Alternatively, a moderate cut-off level may designate that pages ranging from “highly relevant” to “somewhat related” to the group interest be moved to the cache. In addition, the cut-off level may be varied and may be modified to account for a cache size (i.e. high cut-off level for a smaller available cache).

A further determination may be made as to the correspondence between the tag information and the group interest thereby producing an overall correspondence value. This allows for a user group with multiple interests to distinguish correspondence levels between the interests. In one embodiment, this determination may be made by multiplying the pertinence score 111, 112 to the interest relation value 110 to produce the overall correspondence value. For example, the Boston Marathon site pertinence score of “100” multiplied by an interest relation value of “10” yields an overall correspondence value of “1000”. An air travel site belonging to a different group interest may have a pertinence score of “100”, and when multiplied by an interest relation value of “50” yields an overall correspondence value of “5000”. In this example, the two sites share equal pertinence score, but the air travel site has a greater overall correspondence value due to its membership in a different group interest.

Once it is determined that the tag information corresponds to the group interest, the Web pages including tag information are placed into the server cache (Step 66). In one embodiment, Web pages not corresponding to the group interest may reside on a disk array. Once correspondence is determined, Web pages corresponding to the group interest (i.e. having greatest pertinence scores) may be moved to the cache. Furthermore, Web pages may also be cached based on their standing compared to other group interests (i.e. based on their overall correspondence value). Moving the popular topic associated Web pages to the cache may include copying or moving the data information associated with the page to the cache. Placing Web pages corresponding to group interests may provide quicker access to data objects with the same or less storage retrieval infrastructure. This strategy may achieve this by “knowing” in advance what data objects will become popular soon. This may provide a competitive advantage to such systems utilizing this strategy.

Those skilled in the art will recognize that the aforementioned method steps may be varied in sequence without departing from the spirit, scope, and utility of the invention. For example, the tag information may be read from a Web page (Step 63) prior to the provision of a user group (Step 60). The described method may be repeated indefinitely to ensure a dynamic re-allocation of Web pages on the server disk array and cache. For example, user groups may be repetitively defined and modified. In addition, information object access patterns may be continuously monitored to update and modify the group interests.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. Method of allocating data objects stored on a server system comprising:
providing at least one user group;
determining tag information for the data objects;
determining at least one group interest for the user group;
determining whether the tag information corresponds to the group interest, and if there is correspondence, placing data objects including tag information of said group interest into a server cache.

2. The method of claim 1 wherein the data object includes a Web page.

3. The method of claim 2 wherein the Web page comprises information provided as hypertext mark-up language (HTML) or extensible mark-up language (XML), including tag information provided as hypertext transfer protocol (HTTP).

4. The method of claim 1 wherein determining tag information comprises reading data object tag information.

5. The method of claim 1 wherein determining tag information comprises generating data object tag information.

6. The method of claim 1 wherein determining at least one group interest for the user group comprises managing predictive data.

7. The method of claim 6 wherein managing predictive data comprises considering static predictions.

8. The method of claim 6 wherein managing predictive data comprises considering access patterns.

9. The method of claim 1 wherein determining whether the tag information corresponds to the group interest comprises determining interest match information.

10. The method of claim 1 wherein determining whether the tag information corresponds to the group interest comprises determining a pertinence score.

11. A computer usable medium including a program for allocating data objects stored on a server system comprising:
computer readable program code for providing at least one user group;
computer readable program code for determining tag information for the data objects;
computer readable program code for determining at least one group interest for the user group; and
computer readable program code for determining whether the tag information corresponds to the group interest, and if there is correspondence, placing data objects including tag information of said group interest into a server cache.

12. The computer usable medium of claim 11 wherein the data object comprises a Web page.

13. The computer usable medium of claim 12 wherein the Web page comprises information provided as hypertext mark-up language (HTML) or extensible mark-up language (XML), including tag information provided as hypertext transfer protocol (HTTP).

14. The computer usable medium of claim 11 wherein determining tag information comprises reading data object tag information.

15. The computer usable medium of claim 11 wherein determining tag information comprises generating data object tag information.

16. The computer usable medium of claim 11 wherein determining at least one group interest for the user group comprises managing predictive data.

17. The computer usable medium of claim 11 wherein managing predictive data comprises considering static predictions.

18. The computer usable medium of claim 11 wherein managing predictive data comprises considering access patterns.

19. The computer usable medium of claim 11 wherein determining whether the tag information corresponds to the group interest comprises determining interest match information.

20. The computer usable medium of claim 11 wherein determining whether the tag information corresponds to the group interest comprises determining a pertinence score.

21. System for allocating data objects stored on a server system comprising:
means for providing at least one user group;
means for determining tag information for the data objects;
means for determining at least one group interest for the user group;
means for determining whether the tag information corresponds to the group interest, and if there is correspondence, placing data objects including tag information of said group interest into a server cache.
